(19) United States
(12) Patent Application Publication
(10) Pub. No.: US 2014/0030595 A1
(43) Pub. Date: Jan. 30, 2014

(54) LITHIUM-ION SECONDARY BATTERY

(71) Applicant: HITACHI, LTD., Tokyo (JP)

(72) Inventors: Yuko KISHIMI, Ibaraki-shi (JP); Mitsuhiro KISHIMI, Ibaraki-shi (JP)

(73) Assignee: HITACHI, LTD., Tokyo (JP)

(21) Appl. No.: 13/749,422

(22) Filed: Jan. 24, 2013

(30) Foreign Application Priority Data
Jul. 24, 2012 (JP) 2012-163245

(51) Int. Cl. H01M 2/16

(52) U.S. Cl. CPC H01M 2/1673
USPC 429/218.1; 429/246

(57) ABSTRACT

The lithium-ion secondary battery includes a positive electrode, a negative electrode, a separator and a nonaqueous electrolyte. A positive electrode material mixture layer of the positive electrode has a volume density Vc of 62 vol. % or more and a capacity per unit area of 2 mAh/cm² or more, the positive electrode satisfies C²/Vc≧200 [C (mAh/g): initial charge capacity per 1 g of positive electrode active material]. A negative electrode material mixture layer of the negative electrode has a volume density Va of 62 vol. % or more and a capacity per unit area of 2.5 mAh/cm² or more, the negative electrode satisfies A²/Va≧1700 [A (mAh/g): initial discharge capacity per 1 g of negative electrode active material]. The separator has an air permeance of 200 sec./100 mL or less, the air permeance being determined by the Gurley method, the separator satisfies d/(A²/Va)≦0.039 [d (nm): average pore size of the separator]. The positive electrode and the negative electrode satisfy (A²/Va)/(C²/Vc)≦30.

### BACKGROUND OF THE INVENTION

1. Field of the Invention

The present invention relates to a lithium-ion secondary battery with a high capacity and favorable charge and discharge load characteristics.

2. Description of Related Art

As batteries for use in portable electronic devices, hybrid vehicles and the like, lithium-ion secondary batteries have been developed at a rapid pace. Typically, such a lithium-ion secondary battery uses a positive electrode that includes a positive electrode material mixture layer containing a positive electrode active material and formed on one side or both sides of a current collector and a negative electrode that includes a negative electrode material mixture layer containing a negative electrode active material and formed on one side or both sides of a current collector. Further, for lithium-ion secondary batteries, commonly, lithium-containing complex oxides such as lithium cobaltate, lithium nickelate and lithium manganate are used as positive electrode active materials and carbon materials and the like are used as negative electrode active materials.

Further, lithium-ion secondary batteries need to have improvements in various battery characteristics such as an increase in capacity as devices using them have grown more powerful.

For example, JP 2008-66278 A proposes a technique of improving a battery's charge-discharge cycle characteristics by configuring an active material layer (negative electrode material mixture layer) of the negative electrode and a separator to have a specific porosity and a specific air permeance, respectively, so as to enhance the circulation of nonaqueous electrolyte.

In order to increase a lithium-ion secondary battery's capacity, a technique has been under consideration which involves, for example, increasing a positive electrode material mixture layer of a positive electrode and a negative electrode material mixture layer of a negative electrode in thickness to increase the amount of positive electrode active material and negative electrode active material charged in the battery.

However, an increase in the thickness of the positive electrode material mixture layer and the negative electrode material mixture layer causes deterioration of the load characteristics of the battery. Therefore, in order to increase the lithium-ion secondary battery's capacity by the above-mentioned technique, a technique of improving the load characteristics needs to be developed.

With the foregoing in mind, the present invention provides a lithium-ion secondary battery with a high capacity and favorable charge and discharge load characteristics.

### SUMMARY OF THE INVENTION

The lithium-ion secondary battery of the present invention is a lithium-ion secondary battery including a positive electrode, a negative electrode, a separator and a nonaqueous electrolyte. The positive electrode is provided with a positive electrode material mixture layer containing a positive electrode active material, the positive electrode material mixture layer has a volume density Vc of 62 vol. % or more and a capacity per unit area of 2 mAh/cm² or more, the positive electrode satisfies the following formula (1):

C²/Vc≧200 (1)

where C (mAh/g) is the initial charge capacity per 1 g of positive electrode active material, C being measured using Li as a counter electrode and at a charge voltage of 4.2 V,

the negative electrode is provided with a negative electrode material mixture layer containing a negative electrode active material, the negative electrode material mixture layer has a volume density Va of 62 vol. % or more and a capacity per unit area of 2.5 mAh/cm² or more, the negative electrode satisfies the following formula (2):

A²/Va≧1700 (2)

where A (mAh/g) is the initial discharge capacity per 1 g of negative electrode active material, A being measured using Li as a counter electrode and at a discharge voltage of 0.01 V,

the separator has an air permeance of 200 sec./100 mL or less, the air permeance being determined by the Gurley method, the separator satisfies the following formula (3):

d/(A²/Va)≦0.039 (3)

where d (nm) is an average pore size of the separator, and

the positive electrode and the negative electrode satisfy the following formula (4):

(A²/Va)/(C²/Vc)≦30 (4).

According to the present invention, it is possible to provide a lithium-ion secondary battery with a high capacity and favorable charge and discharge load characteristics.

### BRIEF DESCRIPTION OF THE DRAWINGS

FIG. 1 is a graph depicting the relationship between the discharge and charge load characteristics of each of the test cells of Examples 2, 8 and 9 and Comparative Examples 6 to 8 and the air permeance of each of the separators used in these test cells.

FIG. 2 is a graph depicting the relationship between the discharge and charge load characteristics of each of the test cells of Examples 2 and 5 to 7 and Comparative Examples 4 and 5 and C²/Vc of each of the positive electrodes used in these test cells.

FIG. 3 is a graph depicting the relationship between the discharge and charge load characteristics of each of the test cells of Examples 1 to 4 and Comparative Examples 1 to 3 and A²/Va of each of the negative electrodes used in these test cells.

FIG. 4 is a graph depicting the relationship between the discharge and charge load characteristics of each of the test cells of Examples 1 to 4 and Comparative Examples 1 to 3 and d/(A²/Va) of these test cells.

FIG. 5 is a graph depicting the relationship between the discharge and charge load characteristics of each of the test cells of Examples 10 to 12 and Comparative Examples 6, 9 and 10 and A²/Va of each of the negative electrodes used in these test cells.

FIG. 6 is a graph depicting the relationship between the discharge and charge load characteristics of each of the test cells of Examples 10 to 12 and Comparative Examples 6, 9 and 10 and d/(A²/Va) of these test cells.

FIG. 7 is a graph depicting the relationship between the discharge and charge load characteristics of each of the test cells of Examples 9 and 13 to 16 and Comparative Example 11 and A²/Va of each of the negative electrodes used in these test cells.

FIG. 8 is a graph depicting the relationship between the discharge and charge load characteristics of each of the test cells of Examples 9 and 13 to 16 and Comparative Example 11 and d/(A²/Va) of these test cells.

### DETAILED DESCRIPTION OF THE INVENTION

From the viewpoint of improving load characteristics of lithium-ion secondary batteries, it has been considered conventionally that it is preferable to increase the speed at which lithium ions move between the positive and negative electrodes. Typically, for example, a separator placed between the positive and negative electrodes is configured to have high permeability (i.e., low air permeance determined by the Gurley method) to allow lithium ions to pass therethrough more smoothly.

However, of combinations of positive and negative electrodes used in lithium-ion secondary batteries, in many cases, positive electrodes are higher in reactivity than negative electrodes when the two are compared. Studies conducted by the present inventors revealed that when the capacity of such a lithium-ion secondary battery was enhanced by increasing the positive electrode material mixture layer and the negative electrode material mixture layer in thickness, and the load characteristics (the ratio of the charge or discharge capacity at a high load to the charge or discharge capacity at a low load) of the battery were evaluated, the discharge load characteristics improved with a decline in the air permeance (an increase in permeability) of the separator. On the other hand, during charging, the charge load characteristics improved with a decline in the air permeance of the separator as long as the air permeance was within a certain range but deteriorated when the air permeance fell below the certain range.

Further, in regard to lithium-ion secondary batteries configured in the same manner as the above-mentioned battery except for using various separators that were different from each other in air permeance, the diffusion resistance of lithium ions during charging and discharging of each battery was evaluated. It was found that the diffusion resistance of lithium ions dropped with a decline in the air permeance of the separator during discharging. On the other hand, during charging, the diffusion resistance of lithium ions dropped with a decline in the air permeance of the separator as long as the air permeance was within a certain range but increased when the air permeance fell below the certain range.

A lithium-ion secondary battery's charge and discharge load characteristics are dependent on the diffusion resistance of lithium ions during charging and discharging, respectively. That is, a lithium-ion secondary battery's discharge load characteristics improve with an increase in the permeability of the separator, as has been thought conventionally. However, when it comes to charge load characteristics, they improve to a certain extent with an increase in the permeability of the separator but deteriorate afterwards with an improvement in the permeability.

It is assumed that the following mechanisms were to blame for the phenomena occurred in the evaluations of the load characteristics and the evaluations of diffusion resistance of lithium ions, both of which were conducted in regard to the lithium-ion secondary batteries using a positive electrode and a negative electrode lower in reactivity than the positive electrode in combination.

<(a) A Lithium-Ion Secondary Battery Using a Separator Having a High Air Permeance (Low Permeability Separator)>

When this lithium-ion secondary battery was charged at a high load, most of the lithium ions that were emitted from the positive electrode to the negative electrode at a stretch were obstructed by the low permeability separator and were held up. Consequently, for example, the number of lithium ions that were able to reach the negative electrode within a certain time period declined. The negative electrode had low reactivity and thus could accept only a small number of lithium ions within the time period. However, in this case, the number of lithium ions that were able to reach the negative electrode became smaller than the number of lithium ions that could be accepted by the negative electrode, so that the negative electrode could accept lithium ions comfortably. Hence, it is considered that the level of polarization of the negative electrode surface declined. However, since the number of carriers for providing electric conduction was small due to a small number of lithium ions on the negative electrode side, it is considered that the diffusion resistance during charging increased and thus the charge capacity declined.

And when this charged lithium-ion secondary battery was discharged at a high load, the positive electrode was able to comfortably accept lithium ions that were emitted from the negative electrode and reached the positive electrode because the positive electrode had high reactivity and thus was able to accept a large number of lithium ions within a certain time period. However, the number of lithium ions that reached the positive electrode became smaller because lithium ions emitted from the negative electrode to the positive electrode had been obstructed somewhat by the separator and held up. Since there were only a small number of carriers for providing electric conduction, it is considered that the diffusion resistance during discharging increased and thus the discharge capacity declined.

<(b) A Lithium-Ion Secondary Battery that Showed Particularly Favorable Charge Load Characteristics in the Load Characteristic Evaluations and Particularly Small Lithium Ion Diffusion Resistance During Charging in the Lithium Ion Diffusion Resistance Evaluations>

When this lithium-ion secondary battery was charged at a high load, lithium ions emitted from the positive electrode to the negative electrode at a stretch were obstructed somewhat by the separator and were held up. However, since the separator used in this lithium-ion secondary battery had a lower air permeance (i.e., having favorable permeability) than that of the separator used in the lithium-ion secondary battery of the case (a), the number of lithium ions that were able to reach the negative electrode within the certain time period was larger than that in the case (a) and was considered to be about the same as the number of lithium ions that could be accepted by the negative electrode within the time period. Thus, it is considered that lithium ions reacted adequately in the vicinity of the negative electrode and the negative electrode was able to accept lithium ions comfortably, so that the level of polarization of the negative electrode surface declined and the diffusion resistance of lithium ions dropped, thereby increasing the charge capacity.

And when this charged lithium-ion secondary battery was discharged at a high load, of lithium ions emitted from the negative electrode, those that were able to reach the positive electrode within the certain time period declined somewhat in number due to the obstruction by the separator. However, the positive electrode had high reactivity and thus was able to comfortably accept lithium ions that reached the positive electrode and the decline in the number of carriers for providing electric conduction was smaller than that in the case (a). Thus, it is considered that the diffusion resistance of lithium ions declined and the discharge capacity also increased.

<(c) A Lithium-Ion Secondary Battery Using a Separator Having a Lower Air Permeance (Having Favorable Permeability) than that of the Separator Used in the Lithium-Ion Secondary Battery of the Case (b)>

When this lithium-ion secondary battery was charged at a high load, lithium ions were emitted from the positive electrode to the negative electrode at a stretch. Since only a small resistance was exerted to the lithium ions when they passed through the separator, the number of lithium ions that were able to reach the negative electrode within the certain time period increased. However, the negative electrode had low reactivity, so that the number of lithium ions that reached the negative electrode exceeded the number of lithium ions that could be accepted by the negative electrode. Thus, it is considered that reactions in the negative electrode lagged behind and the level of polarization of the negative electrode surface increased, so that the diffusion resistance of lithium ions became larger than that in the case (b) and thus the charge capacity declined.

On the other hand, when this charged lithium-ion secondary battery was discharged at a high load, of lithium ions emitted from the negative electrode, those that were able to reach the positive electrode within the certain time period increased in number than that in the case (b). The positive electrode had high reactivity and thus was able to comfortably accept lithium ions that reached the positive electrode, and the decline in the number of carriers for providing electric conduction was smaller than that in the case (b). Hence, it is considered that the diffusion resistance of lithium ions further declined and the discharge capacity further increased.

In this way, in a lithium-ion secondary battery using a positive electrode and a negative electrode lower in reactivity than the positive electrode in combination, the number of lithium ions in the vicinity of the positive electrode increases as a separator has a lower air permeance determined by the Gurley method and more favorable permeability. Therefore, by increasing the number of carriers for providing electric conduction, the diffusion resistance of lithium ions can be reduced, thereby improving the discharge load characteristics. However, as described above, the charge load characteristics of the lithium-ion secondary battery rather deteriorate when the air permeance of the separator is simply reduced to improve the permeability

For these reasons, in the lithium-ion secondary battery of the present invention, the discharge load characteristics are improved by adjusting the air permeance of the separator, and at the same time, the charge load characteristics can also be improved by adjusting the reactivity of the positive electrode and that of the negative electrode and adopting a separator configured in accordance with the reactivity of the negative electrode.

The positive electrode of the lithium-ion secondary battery according to the present invention includes a positive electrode material mixture layer containing a positive electrode active material and formed on at least one side of a current collector. And the positive electrode material mixture layer of the positive electrode has a high capacity as it has a capacity per unit area of 2 mAh/cm² or more. The highest capacity per unit area is not particularly limited but is about 30 mAh/cm².

Further, the positive electrode satisfies the following formula (1):

C²/Vc≧200 (1)

where C (mAh/g) is the initial charge capacity per 1 g of positive electrode active material (hereinafter may be referred to as “the capacity C of the positive electrode” for brevity), C being measured using Li as a counter electrode and at a charge voltage of 4.2 V, and Vc (%) is the volume density of the positive electrode material mixture layer.

C²/Vc in the formula (1) is an indicator expressing the reactivity of the positive electrode. When it satisfies the relationship expressed by the formula (1), the positive electrode has high reactivity and can receive lithium ions at high speed, so that lithium ions emitted from the negative electrode to the positive electrode when the battery is discharged can be immediately intercalated into the positive electrode without being held up in the vicinity of the positive electrode surface. Thus, it is possible to reduce the level of polarization of the positive electrode surface to make the charge load characteristics favorable. The value of C²/Vc is more preferably 450 or more. The highest value of C²/Vc is not particularly limited but is about 3000.

The volume density Vc of the positive electrode material mixture layer is preferably as small as possible because the reactivity of the positive electrode can be enhanced by increasing the surface area of the positive electrode material mixture layer, i.e., the reaction area of the positive electrode surface. Specifically, the volume density Vc is preferably 80 vol. % or less. However, if the volume density of the positive electrode material mixture layer is too small, the percentage of voids in the positive electrode material mixture layer becomes excessive and the electric conductivity in the positive electrode material mixture layer may deteriorate. Therefore, the volume density Vc of the positive electrode material mixture layer is 62 vol. % or more, and preferably 64 vol. % or more.

The volume density Vc of the positive electrode material mixture layer as used herein refers to the volume of the positive electrode material mixture layer exclusive of voids being expressed as a percentage, where the apparent volume of the positive electrode material mixture layer (the volume of the mixture layer including voids) is 100%, and specifically it is determined as follows. First, the mass of the positive electrode is measured, and then from the obtained value the mass of the positive electrode current collector is subtracted to determine the mass of the positive electrode material mixture layer. The thickness of the positive electrode material mixture layer, which is determined by subtracting the thickness of the positive electrode current collector from an average thickness of five locations of the positive electrode, is multiplied by the area of the positive electrode material mixture layer to determine the volume of the positive electrode material mixture layer, and the mass of the positive electrode material mixture layer is divided by the volume of the positive electrode material mixture layer to determine the density Dc of the positive electrode material mixture layer. Next, from the true specific gravity and mass ratio of all of the materials included in the positive electrode material mixture layer, the true density Mc of the positive electrode material mixture layer is determined. And the volume density Vc is determined from the following formula using the density Dc and the true density Mc of the positive electrode material mixture layer:

Vc=Dc×100/Mc.

Further, for example, when the positive electrode material mixture layer contains 91 parts by mass of positive electrode active material (true specific gravity: 4.65), 4.5 parts by mass of conductive assistant (true specific gravity: 2.2), 4 parts by mass of polyvinylidene fluoride (binder) (true specific gravity: 1.79) and 0.5 parts by mass of polyvinyl pyrrolidone (dispersant) (true specific gravity: 1.2) and has a density Dc of 2.72 g/cm³, the true density Mc and the volume density of Vc of the positive electrode material mixture layer are as follows:

Mc=100/(91/4.65+4.5/2.2+4/1.79+0.5/1.2)=4.12

Vc=2.72×100/4.12=66 (vol. %).

The initial charge capacity C per 1 g of positive electrode active material is determined by, more specifically, producing a model cell using the positive electrode as a working electrode, metal Li as a counter electrode and the same nonaqueous electrolyte as that used in the lithium-ion secondary battery, charging the model cell at a constant current of 0.02 C until the voltage becomes 4.2 V to determine the charge capacity and dividing the charge capacity by the mass of the positive electrode active material included in the positive electrode.

It is possible to control the capacity per unit area of the positive electrode material mixture layer to within the above-mentioned numerical range by choosing an appropriate type of positive electrode active material and adjusting the thickness of the positive electrode material mixture layer (including an adjustment to the amount per unit area of positive electrode active material in the positive electrode material mixture layer). It is known that positive electrode active materials have unique capacities from one type to another and the values of the capacities are also made public. Thus, such a value is used in calculating the capacity per unit area of the positive electrode material mixture layer. Further, the capacity C of the positive electrode can also be controlled by choosing an appropriate type of positive electrode active material.

Specific examples of positive electrode active materials that can be used in the positive electrode according to the present invention include layered lithium-containing transition metal oxides represented by Li_{1+c}M¹O₂ (−0.1<c<0.1, M¹: Co, Ni, Mn, Al, Mg, etc.), layered oxides composed of solid solution represented by (1-x)Li₂MnO₃-xLiMO₂ (0.2<x<0.7, M: Co, Ni, Mn, Al, Mg, etc.), lithium manganese oxides having a spinel structure such as LiMn₂O₄ and those obtained by partially replacing elements of LiMn₂O₄ with other elements, and olivine-type compounds represented by LiM²PO₄ (M²: Co, Ni, Mn, Fe, etc.). Specific examples of the layered lithium-containing transition metal oxides include oxides at least containing Co, Ni and Mn (such as LiMn_{1/3}Ni_{1/3}Co_{1/3}O₂, LiMn_{5/12}Ni_{5/12}Co_{1/6}O₂, and LiMn_{3/5}Ni_{1/5}Co_{1/5}O₂) in addition to LiCoO₂ and LiNi_{1-d}Co_{d-e}AlₑO₂ (0.1≦d≦0.3, 0.01≦e≦0.2). As the positive electrode active material, these examples may be used alone or in combination of two or more.

Commonly, a conductive assistant and a binder are also included in the positive electrode material mixture layer together with the positive electrode active material. Specific examples of the conductive assistant used in the positive electrode material mixture layer include graphites such as natural graphite (such as flake graphite) and artificial graphite; carbon blacks such as acetylene black, Ketjen black, channel black, furnace black, lamp black and thermal black; and carbon fibers. Further, examples of the binder used in the positive electrode material mixture layer include polyvinylidene fluoride (PVDF), polytetrafluoroethylene (PTFE), styrene-butadiene rubber (SBR) and carboxymethyl cellulose (CMC).

The positive electrode can be produced through the steps of dispersing a positive electrode material mixture containing the positive electrode active material, the conductive assistant, the binder and the like in a solvent such as water or an organic solvent including N-methyl-2-pyrrolidone (NMP) to prepare a positive electrode material mixture-containing composition (such as a paste or a slurry), applying the positive electrode material mixture-containing composition onto one side or both sides of a current collector, followed by drying, and optionally pressing the current collector. However, the positive electrode does not have be produced by this method and may be produced by other methods.

As for the composition of the positive electrode material mixture layer, for example, the amount of positive electrode active material is preferably 80 to 99.8 mass %, the amount of conductive assistant is preferably 0.1 to 10 mass %, and the amount of binder is preferably 0.1 to 10 mass %.

The thickness of the positive electrode material mixture layer may be adjusted such that the capacity per unit area of the positive electrode is within the above-mentioned numerical range. Specifically, it is preferable that the thickness of the positive electrode material mixture layer is 70 to 400 μm per one side of the current collector.

For the positive electrode current collector, a foil, a punched metal, a mesh or an expanded metal made of aluminum may be used, for example. Generally, an aluminum foil is used. The thickness of the positive electrode current collector is preferably 10 to 30 μm.

The negative electrode of the lithium-ion secondary battery according to the present invention includes a negative electrode material mixture layer containing a negative electrode active material and formed on at least one side of a current collector. And the negative electrode material mixture layer of the negative electrode has a high capacity as it has a capacity per unit area of 2.5 mAh/cm² or more. The highest capacity per unit area is not particularly limited but is about 40 mAh/cm².

Further, the negative electrode satisfies the following formula (2):

A²/Va≧1700 (2)

where A (mAh/g) is the initial discharge capacity per 1 g of negative electrode active material (hereinafter may be referred to as “the capacity A of the negative electrode” for brevity), A being measured using Li as a counter electrode and at a discharge voltage of 0.01 V, and Va (%) is the volume density of the negative electrode material mixture layer.

A²/Va in the formula (2) is an indicator expressing the reactivity of the negative electrode. When it satisfies the relationship expressed by the formula (2), the negative electrode has relatively high reactivity and can receive lithium ions at relatively high speed, so that lithium ions emitted from the positive electrode and arrived at the negative electrode when the battery is charged can be intercalated into the negative electrode relatively promptly. Thus, it is possible to reduce the level of polarization of the negative electrode surface to make the charge load characteristics favorable. The value of A²/Va is more preferably 1800 or more. The highest value of A²/Va is not particularly limited but is about 10000.

The volume density Va of the negative electrode material mixture layer is preferably as small as possible because the reactivity of the negative electrode can be enhanced by increasing the surface area of the negative electrode material mixture layer, i.e., the reaction area of the negative electrode surface. Specifically, the volume density Va is preferably 80 vol. % or less. However, if the volume density of the negative electrode material mixture layer is too small, the percentage of voids in the negative electrode material mixture layer becomes excessive and the electric conductivity in the negative electrode material mixture layer may deteriorate. Therefore, the volume density Va of the negative electrode material mixture layer is 62 vol. % or more, and preferably 64 vol. % or more.

The volume density Va of the negative electrode material mixture layer as used herein refers to the volume of the negative electrode material mixture layer exclusive of voids being expressed as a percentage, where the apparent volume of the negative electrode material mixture layer (the volume of the mixture layer including voids) is 100%. Specifically, the density Da and the true density Ma of the negative electrode material mixture layer are determined in the same manner as in the case of determining the volume density Vc of the positive electrode material mixture layer, and the volume density Va is calculated from the following formula using the density Da and the true density Ma:

Va=Da×100/Ma.

Further, the initial discharge capacity A per 1 g of negative electrode active material is determined by, more specifically, producing a model cell using the negative electrode as a working electrode, metal Li as a counter electrode and the same nonaqueous electrolyte as that used in the lithium-ion secondary battery, discharging the model cell at a constant current of 0.02 C until the voltage becomes 0.01 V to determine the discharge capacity and dividing the discharge capacity by the mass of the negative electrode active material included in the negative electrode.

It is possible to control the capacity per unit area of the negative electrode material mixture layer to within the above-mentioned numerical range by choosing an appropriate type of negative electrode active material and adjusting the thickness of the negative electrode material mixture layer (including an adjustment to the amount per unit area of negative electrode active material in the negative electrode material mixture layer). It is known that negative electrode active materials have unique capacities from one type to another and the values of the capacities are also made public. Thus, such a value is used in calculating the capacity per unit area of the negative electrode material mixture layer. Further, the capacity A of the negative electrode can also be controlled by choosing an appropriate type of negative electrode active material.

Specific examples of negative electrode active materials that can be used in the negative electrode according to the present invention include: carbon materials such as graphites [such as natural graphite; and artificial graphite obtained by graphitizing easily-graphitizable carbon such as pyrolytic carbons, mesophase carbon microbeads (MCMB) or carbon fibers at 2800° C. or higher], pyrolytic carbons, cokes, glassy carbons, calcined organic polymer compounds, MCMB, carbon fibers and active carbon; metals that can be alloyed with lithium (such as Si and Sn); and materials (such as alloys and oxides) containing these metals. As the negative electrode active material, these examples may be used alone or in combination of two or more.

Among the above-mentioned examples of the negative electrode active material, it is preferable to use materials containing silicon (Si) and oxygen (O) as constituent elements (where, the atomic ratio (x) of 0 to Si is 0.5≦x≦1.5; hereinafter the materials will be referred to as “SiOₓ”) in order to increase the capacity of the battery in particular.

SiOₓ may include an Si microcrystalline or amorphous phase. In this case, the atomic ratio between Si and O is a ratio including Si in the Si microcrystalline or amorphous phase. That is, the materials represented by SiOₓ include those having such a structure that Si (e.g., microcrystalline Si) is dispersed in an amorphous SiO₂ matrix. In this case, the atomic ratio x, including the amorphous SiO₂ and Si dispersed therein, may satisfy 0.5≦x≦1.5. For example, in the case of a material having a structure in which Si is dispersed in an amorphous SiO₂ matrix and the mole ratio between SiO₂ and Si is 1:1, x is equal to 1 (x=1). Thus, this material can be represented by the structural formula SiO. When a material having such a structure is analyzed by, for example, X-ray diffractometry, a peak resulting from the presence of Si (microcrystalline Si) may not be observed. However, when the material is observed under a transmission electron microscope, the presence of impalpable Si can be recognized.

Since SiOₓ is poor in conductivity, the surface of SiOₓ may be coated with carbon. As a result, a conductive network can be formed more favorably in the negative electrode.

For example, carbon such as low crystalline carbon, carbon nanotubes or vapor-grown carbon fibers can be used to coat the surface of SiOₓ.

When the surface of SiOₓ is coated with carbon by heating hydrocarbon gas in a vapor phase and depositing on the surface of the SiOₓ particles carbon resulting from the thermal decomposition of the hydrocarbon gas [chemical vapor deposition (CVD)], the hydrocarbon gas can be distributed throughout the SiOₓ particles. Thus, a thin and uniform coating containing conductive carbon (i.e., carbon coating layer) can be formed on the surface of the particles and in holes in the surface. Thus, conductivity can be imparted to the SiOₓ particles uniformly using a small amount of carbon.

Although toluene, benzene, xylene, mesitylene or the like can be used as the liquid source of the hydrocarbon gas used in CVD, toluene is particularly preferable because it is easy to handle. The hydrocarbon gas can be obtained by evaporating (e.g., bubbling with nitrogen gas) any of these liquid sources. Further, it is also possible to use methane gas, ethylene gas, acetylene gas, and the like.

The treatment temperature used in CVD is preferably, for example, 600 to 1200° C. Further, SiOₓ to be subjected to CVD is preferably of granules (composite particles) granulated by a known method.

When coating the surface of SiOₓ with carbon, the amount of carbon is preferably 5 parts by mass or more and more preferably 10 parts by mass or more, and preferably 95 parts by mass or less and more preferably 90 parts by mass or less with respect to 100 parts by mass of SiOₓ.

As in the case of other high capacity negative electrode materials, SiOₓ undergoes a significant volume change associated with charging/discharging of the battery. Thus, it is preferable to use SiOₓ and graphite in combination as the negative electrode active materials. This makes it possible to achieve an increased capacity resulting from the use of SiOₓ, while suppressing expansion/contraction of the negative electrode associated with charging/discharging of the battery, and to maintain the charge-discharge cycle characteristics at a higher level.

When using SiOₓ and graphite in combination as the negative electrode active materials, SiOₓ preferably makes up 0.5 mass % or more of the total amount of the negative electrode active materials from the viewpoint of favorably ensuring the capacity increasing effect resulting from the use of SiOₓ. Further, from the viewpoint of suppressing the expansion/contraction of the negative electrode caused by SiOₓ, SiOₓ preferably makes up 10 mass % or less of the total amount of the negative electrode active materials.

Typically, a binder is also included in the negative electrode material mixture layer together with the negative electrode active materials. Any of the various binders mentioned above as the examples of the binder used in the positive electrode material mixture layer can be used as the binder for the negative electrode material mixture layer.

Further, a conductive assistant can also be included in the negative electrode material mixture layer as needed. Any of the various conductive assistants mentioned above as the examples of the conductive assistant used in the positive electrode material mixture layer can be used as the conductive assistant for the negative electrode material mixture layer.

The negative electrode can be produced through the steps of dispersing a negative electrode material mixture containing the negative electrode active materials, the binder, and optionally the conductive assistant and the like in a solvent such as water or an organic solvent including NMP to prepare a negative electrode material mixture-containing composition (such as a paste or a slurry), applying the negative electrode material mixture-containing composition onto one side or both sides of a current collector, followed by drying, and optionally pressing the current collector. However, the negative electrode does not have be produced by this method and may be produced by other methods.

As for the composition of the negative electrode material mixture layer, for example, the amount of negative electrode active material is preferably 80 to 99.8 mass %, and the amount of binder is preferably 0.1 to 10 mass %. Further, when including a conductive assistant in the negative electrode material mixture layer, the amount of conductive assistant in the negative electrode material mixture layer is preferably 0.1 to 10 mass %.

Further, the thickness of the negative electrode material mixture layer may be adjusted such that the capacity per unit area of the negative electrode is within the above-mentioned numerical range. Specifically, it is preferable that the thickness of the negative electrode material mixture layer is 70 to 350 μm per one side of the current collector.

For the negative electrode current collector, a foil, a punched metal, a mesh or an expanded metal made of copper or nickel may be used, for example. Generally, a copper foil is used. The thickness of the negative electrode current collector is preferably 5 to 30 μm.

The present invention is based on the premise that the positive electrode is higher in reactivity than the negative electrode. Thus, when lithium ions are emitted from the positive electrode at high speed and the negative electrode has a problem in accepting the lithium ions during charging, the present invention provides a means for solving such a problem. Specifically, by choosing a positive electrode, a negative electrode and a separator appropriately within the scope of the present invention when the value obtained by dividing the negative electrode reactivity (A²/Va) by the positive electrode reactivity (C²/Vc) is 30 or less, both charge and discharge characteristics become more favorable.

It is preferable that the positive electrode reactivity is higher because that leads to favorable discharge load characteristics. However, when the reactivity of the positive electrode is too high and the balance of reactivity between the positive electrode and the negative electrode is lost considerably, charge load characteristics deteriorate. Although it is possible to resolve such a problem to some extent and to improve charge load characteristics by incorporating the separator pore size into the balance in accordance with the present invention, the range of producible separator pore size is limited. Also, it becomes difficult to achieve favorable charge load characteristics when the reactivity of the positive electrode and that of the negative electrode become significantly out of balance. For these reasons, it is more preferable that the value obtained by dividing the negative electrode reactivity (A²/Va) by the positive electrode reactivity (C²/Vc) is 3.2 or more in terms of obtaining more favorable charge and discharge load characteristics.

The above positive electrode and the above negative electrode are used in the lithium-ion secondary battery of the present invention in the form of a laminated electrode assembly obtained by placing the positive electrode and the negative electrode on one another through the separator, or in the form of a wound electrode assembly that is formed by further winding the laminated electrode assembly in a spiral fashion.

As the separator, one having an air permeance of 200 sec./100 mL or less is used, the air permeance being determined by the Gurley method, in other words, by the method according to Japanese Industrial Standards (JIS) P 8117. By using a separator having such a low air permeance (i.e., having favorable permeability), the discharge load characteristics of the lithium-ion secondary battery can be improved. The air permeance of the separator determined by the Gurley method is preferably 100 sec./100 mL or less.

Further, as the separator, one that satisfies the following formula (3) is used:

d/(A²/Va)≦0.039 (3)

where d (nm) is the average pore size.

Here, d/(A²/Va) is preferably 0.033 or less. The lowest value is not particularly limited but is about 0.001.

As the separator of the lithium-ion secondary battery according to the present invention, one having a low air permeance and thus favorable permeability is used to improve the discharge load characteristics of the battery as described above. If a separator simply having a low air permeance is used, the charge load characteristics of the battery deteriorate as described above. However, when the average pore size d of the separator and A²/Va expressing the reactivity of the negative electrode satisfy the relationship expressed by the formula (3), the charge load characteristics of the battery can be improved even if the separator has a low air permeance as described above. Presumably, the reason for this is due to the following mechanism.

When the lithium-ion secondary battery is charged at a high load, lithium ions are emitted from the highly reactive positive electrode at high speed. If the separator simply has a low air permeance, these lithium ions pass through the separator at high speed and many of them reach the negative electrode within the certain time period as explained in the case (c). And by the number of these lithium ions exceeding the number of lithium ions that can be accepted by the low reactive negative electrode, the level of polarization of the negative electrode surface increases.

However, if a separator has a small pore size in addition to a low air permeance and thus favorable permeability, lithium ions emitted from the positive electrode at high speed more frequently collide with the walls of pores when passing through this separator than through a separator having a large pore size. As a result, the speed at which the lithium ions emitted from the positive electrode pass through the separator can be reduced, so that the number of lithium ions that pass through the separator and reach the negative electrode within the certain time period can be reduced.

Consequently, by configuring the separator to have an average pore size in accordance with the reactivity of the negative electrode such that the relationship between the average pore size d of the separator and A²/Va expressing the reactivity of the negative electrode satisfies the certain range, it is possible to control, through the separator, the number of lithium ions that reach the negative electrode within the certain time period during charging to be one that can be comfortably accepted by the negative electrode within the certain time period. Therefore, by reducing the level of polarization of the negative electrode surface, the charge load characteristics of the battery can be improved.

On the other hand, when discharging at high load a lithium-ion secondary battery using a separator whose air permeance is within the above-mentioned numerical range and whose average pore size d satisfies the formula (3) in relation to A²/Va expressing the reactivity of the negative electrode, the speed at which lithium ions are emitted from the negative electrode is lower than the speed at which lithium ions are emitted from the positive electrode during charging because the negative electrode is lower in reactivity than the positive electrode. Thus, lithium ions emitted from the negative electrode during discharging can pass through the separator without colliding with the walls of pores so much. Consequently, the speed at which lithium ions pass through the separator does not drop even if the average pore size d of the separator is reduced. For these reasons, the discharge load characteristics that are improved due to the separator having a reduced air permeance can be maintained favorably even in a situation where the relationship of the formula (3) is satisfied.

The separator preferably has such a property that its pores close at 80° C. or higher (more preferably 100° C. or higher) and 170° C. or lower (more preferably 150° C. or lower) (i.e., a shutdown function). As long as the average pore size d satisfies the relationship of the formula (3), the separator can be one used in ordinary lithium-ion secondary batteries, for example, a microporous film made of polyolefin such as polyethylene (PE), polypropylene (PP) or an ethylene-propylene copolymer. A microporous film serving as the separator may be a film composed only of PE or PP or a laminate of a PE microporous film and a PP microporous film.

As a polyolefin microporous film, for example, one made of any of the above-mentioned polyolefins and produced by a drawing method, i.e., uniaxially or biaxially drawing a film or sheet made of polyolefin mixed with an organic filler, etc. to form fine pores and then removing the organic filler as needed. Further, as a polyolefin microporous film, it is also possible to use one produced by a pore forming method using a solvent, i.e., one produced by forming a film or sheet using a mixture of any of the above-mentioned examples of polyolefin, other resin and paraffin, and then immersing the film or sheet in a solvent that only dissolves the other resin and paraffin to dissolve only the other resin and paraffin to form pores. Moreover, it is also possible to use a polyolefin microporous film produced by a combination of the drawing method and the pore forming method using a solvent.

The average pore size d of the separator may be a value that satisfies the formula (3) in relation to the value of A²/Va of the negative electrode used in the lithium-ion secondary battery. Specifically, the average pore size d is preferably, for example, 20 nm or more and more preferably 35 nm or more, and preferably 80 nm or less and more preferably 60 nm or less.

The average pore size d of the separator as used herein is a value measured based on the bubble point method according to JIS K 3832.

The porosity of the separator is preferably 45% or more and more preferably 50% or more. When the separator has such porosity and the average pore size d as described above, the air permeance can be controlled to within the above-mentioned numerical range. However, if the porosity of the separator is too high, the strength of the separator may decline. Therefore, the porosity is preferably 75% or less, and more preferably 70% or less. The porosity of the separator as used herein is determined using the following formula.

P={1−(m/t)/(Σa_{i′}ρᵢ)}×100

Where, P is the porosity (%) of the separator, aᵢ is the ratio of the component i to the total mass, where the total mass is taken as 1, ρᵢ is the density (g/cm³) of the component i, m is the mass per unit area (g/cm²) of the separator, and t is the thickness (cm) of the separator.

The thickness of the separator is preferably 15 to 25 μm.

A solution obtained by dissolving an electrolyte salt in an organic solvent can be used as the nonaqueous electrolyte of the lithium-ion secondary battery according to the present invention. Examples of the solvent include aprotic organic solvents such as propylene carbonate (PC), ethylene carbonate (EC), butylene carbonate (BC), dimethyl carbonate (DMC), diethyl carbonate (DEC), methyl ethyl carbonate (MEC), γ-butyrolactone, 1,2-dimethoxyethane, tetrahydrofuran, 2-methyl tetrahydrofuran, dimethyl sulfoxide, 1,3-dioxolane, formamide, dimethyl formamide, dioxolane, acetonitrile, nitromethane, methyl formate, methyl acetate, triester phosphate, trimethoxy methane, dioxolane derivatives, sulfolane, 3-methyl-2-oxazolidinone, propylene carbonate derivatives, tetrahydrofuran derivatives, diethyl ether and 1,3-propane sultone, and these solvents can be used alone or in combination of two or more. Further, amineimide-based solvents and sulfur-containing or fluorine-containing organic solvents can also be used. Among these solvents, a mixed solvent of EC, MEC and DEC is preferred. In this case, it is more preferable that the amount of DEC contained in the mixed solvent is 15 vol. % or more and 80 vol. % or less of the total volume. This is because the stability of the solvent during charging at a high voltage can be enhanced while maintaining the low temperature characteristics and the charge-discharge cycle characteristics of the battery at a high level.

Lithium perchlorate, organoboron lithium salt, salts of fluorine-containing compounds such as trifluoromethanesulfonate, or imide salt can be used suitably as the electrolyte salt of the nonaqueous electrolyte. Specific examples of the electrolyte salt include LiClO₄, LiPF₆, LiBF₄, LiAsF₆, LiSbF₆, LiCF₃SO₃, LiC₄F₉SO₃, LiCF₃CO₂, Li₂C₂F₄(SO₃)₂, LiN(CF₃SO₂)₂, LiC(CF₃SO₂)₃, LiCₙF₂ₙ₊₁SO₃ (2≦n≦7) and LiN(Rf₃OSO₂)₂ [where R_{f} represents a fluoroalkyl group]. These examples of the electrolyte salt may be used alone or in combinations of two or more. In particular, LiPF₆ and LiBF₄ are more preferred because of good charge-discharge characteristics. These fluorine-containing organic lithium salts are highly anionic and prone to ion separation, and thus are readily soluble in the solvent. The concentration of the electrolyte salt in the solvent is not particularly limited but is generally 0.5 to 1.7 mol/L.

Further, for the purpose of improving characteristics such as the level of safety, charge-discharge cycle characteristics and high temperature storability, additives such as vinylene carbonates, 1,3-propane sultone, diphenyl disulfide, cyclohexyl benzene, biphenyl, fluorobenzene, and t-butyl benzene can be added to the nonaqueous electrolyte as appropriate.

Furthermore, the nonaqueous electrolyte can be used in the lithium-ion secondary battery of the present invention in the form of a gel (gel electrolyte) by adding a known gelling agent such as a polymer to the nonaqueous electrolyte.

Since the lithium-ion secondary battery of the present invention has a high capacity and favorable charge and discharge load characteristics, it can be used preferably in applications where such characteristics are required as well as a variety of applications where conventionally known lithium-ion secondary batteries are used.

The present invention is based on the premise that the negative electrode is lower in reactivity than the positive electrode. When the positive electrode is lower in reactivity in comparison with the negative electrode, by replacing the parameters concerning the negative electrode with those concerning the positive electrode in the relational expressions herein described, it is possible to make improvements in the same manner.

Hereinafter; the present invention will be described in detail by way of Examples. However, the present invention is not limited to the following Examples. Further, various parameters described in Examples were determined by the techniques as explained above.

### Comparative Example 1

<Production of Positive Electrode>

93.5 parts by mass of LiMn_{1/3}Ni_{1/3}Co_{1/3}O₂ serving as a positive electrode active material, 4 parts by mass of acetylene black, 2 parts by mass of PVDF and 0.5 parts by mass of polyvinyl pyrrolidone (PVP) were dispersed in NMP to prepare a positive electrode material mixture-containing composition, and the composition was applied onto one side of 15 μm-thick aluminum foil, which would serve as a current collector, with an applicator such that the capacity per unit area would be 3.7 mAh/cm², followed by drying. And after being pressed, the foil was cut into a size of 30×30 mm, thus producing a positive electrode. The positive electrode material mixture layer of the obtained positive electrode had a thickness of 77 μm.

<Production of Negative Electrode>

97.8 parts by mass of scaly graphite (manufactured by Hitachi Chemicals Co., Ltd.), 1.2 parts by mass of CMC and 1 part by mass of SBR were dispersed into 100 parts by mass of water to prepare a negative electrode material mixture-containing composition, and the composition was applied onto one side of 8 μm-thick copper foil, which would serve as a current collector, with the applicator such that the capacity per unit area would be 4.89 mAh/cm², followed by drying. And after being pressed, the foil was cut into a size of 35×35 mm, thus producing a negative electrode. The negative electrode material mixture layer of the obtained negative electrode had a thickness of 103.9 μm.

<Assembly of Model Cell (Lithium-Ion Secondary Battery)>

The positive electrode and the negative electrode as obtained above were laminated through a separator configured as shown in Table 5 (a PE microporous film having a thickness of 16 μm) and they were inserted in a laminated film outer package. After injecting into the outer package a nonaqueous electrolyte (a solution obtained by dissolving LiPF₆ at a concentration of 1.2 mol/L in a mixed solvent of ethylene carbonate and diethyl carbonate at a volume ratio of 2:8), the outer package was sealed, thus producing a test cell.

### Examples 1 and 2 and Comparative Examples 2 and 3

Negative electrodes were produced in the same manner as in Comparative Example 1 except for changing the conditions under which pressing was performed after applying the negative electrode material mixture-containing composition onto copper foils serving as current collectors and drying the applied composition so that the negative electrode material mixture layers would each have a volume density as shown in Table 3. Except for using these negative electrodes, test cells (lithium-ion secondary batteries) were produced in the same manner as in Comparative Example 1.

### Example 3

94.1 parts by mass of scaly graphite (manufactured by Hitachi Chemicals Co., Ltd.), 3.7 parts by mass of SiO whose surface was coated with carbon (carbon formed by CVD) (the mass ratio of SiO to carbon on the SiO surface: 85:15), 1.2 parts by mass of CMC and 1 part by mass of SBR were dispersed in 100 parts by mass of water to prepare a negative electrode material mixture-containing composition, and the composition was applied onto one side of 8 μm-thick copper foil, which would serve as a current collector, with the applicator such that the capacity per unit area would be 3.77 mAh/cm², followed by drying. After being pressed, the foil was cut into a size of 35×35 mm, thus producing a negative electrode. The negative electrode material mixture layer of the obtained negative electrode had a thickness of 57.7 μm. And except for using this negative electrode, a test cell (lithium-ion secondary battery) was produced in the same manner as in Comparative Example 1.

### Example 4

A negative electrode was produced in the same manner as in Example 3 except for changing the conditions under which pressing was performed after applying the negative electrode material mixture-containing composition onto a copper foil serving as a current collector and drying the applied composition so that the negative electrode material mixture layer would have a volume density as shown in Table 3. And except for using this negative electrode, a test cell (lithium-ion secondary battery) was produced in the same manner as in Comparative Example 1.

### Examples 5 and 6 and Comparative Example 4

Positive electrodes were produced in the same manner as in Comparative Example 1 except for changing the conditions under which pressing was performed after applying the positive electrode material mixture-containing composition onto aluminum foils serving as current collectors and drying the applied composition so that the positive electrode material mixture layers would each have a volume density as shown in Table 1. And except for using these positive electrodes, test cells (lithium-ion secondary batteries) were produced in the same manner as in Example 2.

### Example 7

<Production of Positive Electrode>

91 parts by mass of LiMn₂O₄ serving as a positive electrode active material, 4.5 parts by mass of acetylene black, 4 parts by mass of PVDF and 0.5 parts by mass of polyvinyl pyrrolidone (PVP) were dispersed in NMP to prepare a positive electrode material mixture-containing composition, and the composition was applied onto one side of 15 μm-thick aluminum foil, which would serve as a current collector, with the applicator such that the capacity per unit area would be 2.4 mAh/cm², followed by drying. And after being pressed, the foil was cut into a size of 30×30 mm, thus producing a positive electrode. The positive electrode material mixture layer of the obtained positive electrode had a thickness of 100.8 μm.

<Assembly of Model Cell (Lithium-Ion Secondary Battery)>

The positive electrode obtained above and the same negative electrode as that produced in Example 2 were laminated through a separator configured as shown in Table 5 (a PE microporous film having a thickness of 16 μm), and were inserted in a laminated film outer package. After injecting into the outer package a nonaqueous electrolyte (a solution obtained by dissolving LiPF₆ at a concentration of 1.2 mol/L in a mixed solvent of ethylene carbonate and diethyl carbonate at a volume ratio of 3:7), the outer package was sealed, thus producing a test cell.

### Comparative Example 5

A positive electrode was produced in the same manner as in Example 7 except for changing the conditions under which pressing was performed after applying the positive electrode material mixture-containing composition onto an aluminum foil serving as a current collector and drying the applied composition so that the positive electrode material mixture layer would have a volume density as shown in Table 1. And except for using this positive electrode, a test cell (lithium-ion secondary battery) was produced in the same manner as in Example 7.

### Examples 8 and 9 and Comparative Examples 6 to 8

Test cells (lithium-ion secondary batteries) were produced in the same manner as in Example 2 except that separators each having an air permeance and an average pore size as shown in Table 6 were used.

### Example 10 and Comparative Examples 9 and 10

Negative electrodes were produced in the same manner as in Comparative Example 1 except for changing the conditions under which pressing was performed after applying the negative electrode material mixture-containing composition onto copper foils serving as current collectors and drying the applied composition so that the negative electrode material mixture layers would each have a volume density as shown in Table 4. And except for using these negative electrodes and separators each having an air permeance and an average pore size as shown in Table 6, test cells (lithium-ion secondary batteries) were produced in the same manner as in Comparative Example 1.

### Example 11

A test cell (lithium-ion secondary battery) was produced in the same manner as in Example 3 except that a separator having an air permeance and an average pore size as shown in Table 6 was used.

### Example 12

A test cell (lithium-ion secondary battery) was produced in the same manner as in Example 4 except that a separator having an air permeance and an average pore size as shown in Table 6 was used.

### Examples 13 and 14 and Comparative Example 11

Negative electrodes were produced in the same manner as in Comparative Example 1 except for changing the conditions under which pressing was performed after applying the negative electrode material mixture-containing composition onto copper foils serving as current collectors and drying the applied composition so that the negative electrode material mixture layers would each have a volume density as shown in Table 4. And except for using these negative electrodes and separators each having an air permeance and an average pore size as shown in Table 6, test cells (lithium-ion secondary batteries) were produced in the same manner as in Comparative Example 1.

### Example 15

A test cell (lithium-ion secondary battery) was produced in the same manner as in Example 3 except that a separator having an air permeance and an average pore size as shown in Table 6 was used.

### Example 16

A test cell (lithium-ion secondary battery) was produced in the same manner as in Example 4 except that a separator having an air permeance and an average pore size as shown in Table 6 was used.

With regard to the positive electrodes, the negative electrodes, and the separators used in the test cells of Examples and Comparative Examples, Tables 1 and 2 provide the configuration of each positive electrode, Tables 3 and 4 provide the configuration of each negative electrode, and Tables 5 and 6 provide the configuration of each separator and the values of d/(A²/Va) and (A²/Va)/(C²/Vc).

TABLE 1

| | Configuration of positive electrode | | | | |
|---|---|---|---|---|---|
| | | | Volume density Vc | | Thickness of |
| | | | of positive electrode | | positive electrode |
| | Capacity per | Capacity C of | material mixture | | material mixture |
| | unit area | positive electrode | layer | | layer |
| | (mAh/cm²) | (mAh/g) | (vol. %) | C²/Vc | (μm) |
| Comp. Ex. 1 | 3.7 | 185 | 64.7 | 529 | 77 |
| Ex. 1 | 3.7 | 185 | 64.7 | 529 | 77 |
| Ex. 2 | 3.7 | 185 | 64.7 | 529 | 77 |
| Comp. Ex. 2 | 3.7 | 185 | 64.7 | 529 | 77 |
| Comp. Ex. 3 | 3.7 | 185 | 64.7 | 529 | 77 |
| Ex. 3 | 3.7 | 185 | 64.7 | 529 | 77 |
| Ex. 4 | 3.7 | 185 | 64.7 | 529 | 77 |
| Comp. Ex. 4 | 3.7 | 185 | 60.0 | 570 | 83.0 |
| Ex. 5 | 3.7 | 185 | 68.8 | 497 | 72.4 |
| Ex. 6 | 3.7 | 185 | 77.0 | 444 | 64.7 |
| Ex. 7 | 2.4 | 120 | 63.0 | 229 | 100.8 |
| Comp. Ex. 5 | 2.4 | 120 | 73.0 | 197 | 89.0 |

TABLE 2

| | Configuration of positive electrode | | | | |
|---|---|---|---|---|---|
| | | | Volume density Vc | | Thickness of |
| | | | of positive electrode | | positive electrode |
| | Capacity per | Capacity C of | material mixture | | material mixture |
| | unit area | positive electrode | layer | | layer |
| | (mAh/cm²) | (mAh/g) | (vol. %) | C²/Vc | (μm) |
| Comp. Ex. 6 | 3.7 | 185 | 64.7 | 529 | 77 |
| Ex. 8 | 3.7 | 185 | 64.7 | 529 | 77 |
| Comp. Ex. 7 | 3.7 | 185 | 64.7 | 529 | 77 |
| Comp. Ex. 8 | 3.7 | 185 | 64.7 | 529 | 77 |
| Ex. 9 | 3.7 | 185 | 64.7 | 529 | 77 |
| Ex. 10 | 3.7 | 185 | 64.7 | 529 | 77 |
| Comp. Ex. 9 | 3.7 | 185 | 64.7 | 529 | 77 |
| Comp. Ex. 10 | 3.7 | 185 | 64.7 | 529 | 77 |
| Ex. 11 | 3.7 | 185 | 64.7 | 529 | 77 |
| Ex. 12 | 3.7 | 185 | 64.7 | 529 | 77 |
| Ex. 13 | 3.7 | 185 | 64.7 | 529 | 77 |
| Ex. 14 | 3.7 | 185 | 64.7 | 529 | 77 |
| Comp. Ex. 11 | 3.7 | 185 | 64.7 | 529 | 77 |
| Ex. 15 | 3.7 | 185 | 64.7 | 529 | 77 |
| Ex. 16 | 3.7 | 185 | 64.7 | 529 | 77 |

TABLE 3

| | Configuration of negative electrode | | | | |
|---|---|---|---|---|---|
| | | | Volume density Va of | | Thickness of |
| | | | negative electrode | | negative electrode |
| | Capacity per | Capacity A of | material mixture | | material mixture |
| | unit area | negative electrode | layer | | layer |
| | (mAh/cm²) | (mAh/g) | (vol. %) | A²/Va | (μm) |
| Comp. Ex. 1 | 4.89 | 370 | 60.65 | 2257 | 103.9 |
| Ex. 1 | 4.89 | 370 | 65.32 | 2096 | 96.5 |
| Ex. 2 | 4.89 | 370 | 69.98 | 1956 | 90 |
| Comp. Ex. 2 | 4.89 | 370 | 74.65 | 1834 | 84.5 |
| Comp. Ex. 3 | 4.89 | 370 | 81.65 | 1677 | 77.2 |
| Ex. 3 | 3.77 | 420 | 74.65 | 2363 | 57.7 |
| Ex. 4 | 3.77 | 420 | 69.98 | 2521 | 61.5 |
| Comp. Ex. 4 | 4.89 | 370 | 69.98 | 1956 | 90 |
| Ex. 5 | 4.89 | 370 | 69.98 | 1956 | 90 |
| Ex. 6 | 4.89 | 370 | 69.98 | 1956 | 90 |
| Ex. 7 | 4.89 | 370 | 69.98 | 1956 | 90 |
| Comp. Ex. 5 | 4.89 | 370 | 69.98 | 1956 | 90 |

TABLE 4

| | Configuration of negative electrode | | | | |
|---|---|---|---|---|---|
| | | | Volume density Va of | | Thickness of |
| | | | negative electrode | | negative electrode |
| | Capacity per | Capacity A of | material mixture | | material mixture |
| | unit area | negative electrode | layer | | layer |
| | (mAh/cm²) | (mAh/g) | (vol. %) | A²/Va | (μm) |
| Comp. Ex. 6 | 4.89 | 370 | 69.98 | 1956 | 90 |
| Ex. 8 | 4.89 | 370 | 69.98 | 1956 | 90 |
| Comp. Ex. 7 | 4.89 | 370 | 69.98 | 1956 | 90 |
| Comp. Ex. 8 | 4.89 | 370 | 69.98 | 1956 | 90 |
| Ex. 9 | 4.89 | 370 | 69.98 | 1956 | 90 |
| Ex. 10 | 4.89 | 370 | 65.32 | 2096 | 96.5 |
| Comp. Ex. 9 | 4.89 | 370 | 74.65 | 1834 | 84.5 |
| Comp. Ex. 10 | 4.89 | 370 | 81.65 | 1677 | 77.2 |
| Ex. 11 | 3.77 | 420 | 74.65 | 2363 | 57.7 |
| Ex. 12 | 3.77 | 420 | 69.98 | 2521 | 61.5 |
| Ex. 13 | 4.89 | 370 | 65.32 | 2096 | 96.5 |
| Ex. 14 | 4.89 | 370 | 74.65 | 1834 | 84.5 |
| Comp. Ex. 11 | 4.89 | 370 | 81.65 | 1677 | 77.2 |
| Ex. 15 | 3.77 | 420 | 74.65 | 2363 | 57.7 |
| Ex. 16 | 3.77 | 420 | 69.98 | 2521 | 61.5 |

TABLE 5

| | Configuration of separator | | | |
|---|---|---|---|---|
| | Air permeance | Average pore | | (A²/Va)/ |
| | (sec./100 mL) | size d (nm) | d/(A²/Va) | (C²/Vc) |
| Comp. Ex. 1 | 90 | 72.8 | 0.03225 | 427 |
| Ex. 1 | 90 | 72.8 | 0.03474 | 3.96 |
| Ex. 2 | 90 | 72.8 | 0.03721 | 3.70 |
| Comp. Ex. 2 | 90 | 72.8 | 0.03970 | 3.47 |
| Comp. Ex. 3 | 90 | 72.8 | 0.04342 | 3.17 |
| Ex. 3 | 90 | 72.8 | 0.03081 | 4.47 |
| Ex. 4 | 90 | 72.8 | 0.02888 | 4.77 |
| Comp. Ex. 4 | 90 | 72.8 | 0.03721 | 3.43 |
| Ex. 5 | 90 | 72.8 | 0.03721 | 3.93 |
| Ex. 6 | 90 | 72.8 | 0.03721 | 4.40 |
| Ex. 7 | 90 | 72.8 | 0.03721 | 8.56 |
| Comp. Ex. 5 | 90 | 72.8 | 0.03721 | 9.92 |

TABLE 6

| | Configuration of separator | | | |
|---|---|---|---|---|
| | Air permeance | Average pore | | (A²/Va)/ |
| | (sec./100 mL) | size d (nm) | d/(A²/Va) | (C²/Vc) |
| Comp. Ex. 6 | 45 | 79.7 | 0.04074 | 3.70 |
| Ex. 8 | 170 | 44.5 | 0.02275 | 3.70 |
| Comp. Ex. 7 | 400 | 18.0 | 0.00920 | 3.70 |
| Comp. Ex. 8 | 550 | 17.7 | 0.00905 | 3.70 |
| Ex. 9 | 60 | 53.6 | 0.02740 | 3.70 |
| Ex. 10 | 45 | 79.7 | 0.03803 | 3.96 |
| Comp. Ex. 9 | 45 | 79.7 | 0.04346 | 3.47 |
| Comp. Ex. 10 | 45 | 79.7 | 0.04753 | 3.17 |
| Ex. 11 | 45 | 79.7 | 0.03373 | 4.47 |
| Ex. 12 | 45 | 79.7 | 0.03162 | 4.77 |
| Ex. 13 | 60 | 53.6 | 0.02557 | 3.96 |
| Ex. 14 | 60 | 53.6 | 0.02923 | 3.47 |
| Comp. Ex. 11 | 60 | 53.6 | 0.03197 | 3.17 |
| Ex. 15 | 60 | 53.6 | 0.02268 | 4.47 |
| Ex. 16 | 60 | 53.6 | 0.02126 | 4.47 |

Further, the charge and discharge load characteristics of the test cells of Examples and Comparative Examples were evaluated as follows. First, each test cell was charged at a current of 0.2 C until the voltage became 4.2 V to determine the charge capacity (0.2 C charge capacity). Then, each test cell was discharged at a current of 0.2 C until the voltage became 2.5 V to determine the discharge capacity (0.2 C discharge capacity). Next, each test cell was charged at a current of 2 C until the voltage became 4.2 V to determine the charge capacity (2 C charge capacity). Then, each test cell was discharged at a current of 2 C until the voltage became 2.5 V to determine the discharge capacity (2 C discharge capacity). Then, the capacity retention rate of each test cell was calculated by dividing the 2 C discharge capacity by the 0.2 C discharge capacity and expressing the obtained value as a percentage, and the value of this capacity retention rate was used in evaluating the discharge load characteristics of each test cell. Further, the capacity retention rate of each test cell was calculated by dividing the 2 C charge capacity by the 0.2 C charge capacity and expressing the obtained value as a percentage, and the value of this capacity retention rate was used in evaluating the charge load characteristics of each test cell. That is, the higher the capacity retention rate during the discharging, the more favorable the discharge load characteristics of the test cells are, and the higher the capacity retention rate during the charging, the more favorable the charge load characteristics of the test cells are. Tables 7 and 8 provide the evaluation results.

TABLE 7

| | Discharge load characteristics | Charge load characteristics |
|---|---|---|
| | (%) | (%) |
| Comp. Ex. 1 | 48.3 | 30.7 |
| Ex. 1 | 73.2 | 51.5 |
| Ex. 2 | 68.9 | 48.7 |
| Comp. Ex. 2 | 63.4 | 45.7 |
| Comp. Ex. 3 | 40.2 | 28.2 |
| Ex. 3 | 83.5 | 55.8 |
| Ex. 4 | 85.2 | 59.2 |
| Comp. Ex. 4 | 51.6 | 45.2 |
| Ex. 5 | 68.4 | 52.0 |
| Ex. 6 | 65.3 | 47.8 |
| Ex. 7 | 62.3 | 50.0 |
| Comp. Ex. 5 | 31.9 | 26.2 |

TABLE 8

| | Discharge load characteristics | Charge load characteristics |
|---|---|---|
| | (%) | (%) |
| Comp. Ex. 6 | 69.1 | 45.6 |
| Ex. 8 | 67.3 | 53.9 |
| Comp. Ex. 7 | 60.0 | 59.2 |
| Comp. Ex. 8 | 57.3 | 55.5 |
| Ex. 9 | 70.1 | 53.2 |
| Ex. 10 | 74.9 | 49.1 |
| Comp. Ex. 9 | 64.1 | 42.4 |
| Comp. | 46.3 | 31.2 |
| Ex. 10 | | |
| Ex. 11 | 85.6 | 60.3 |
| Ex. 12 | 86.1 | 63.1 |
| Ex. 13 | 75.9 | 60.1 |
| Ex. 14 | 66.4 | 50.3 |
| Comp. | 40.0 | 31.5 |
| Ex. 11 | | |
| Ex. 15 | 83.8 | 65.4 |
| Ex. 16 | 84.2 | 67.2 |

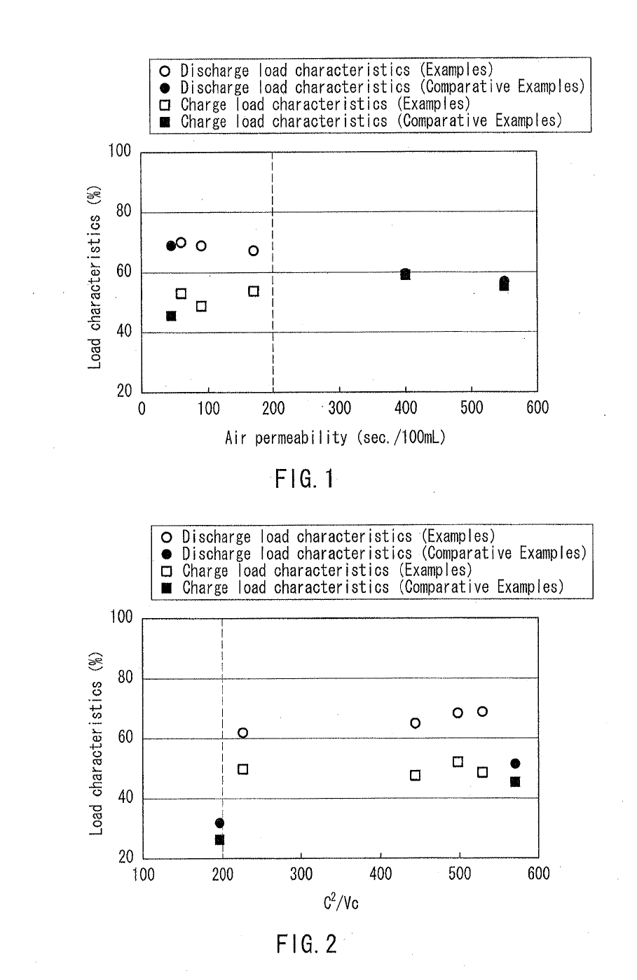

FIG. 1 shows a graph depicting the relationship between the obtained discharge and charge load characteristics of each of the test cells of Examples 2, 8 and 9 and Comparative Examples 6 to 8 and the air permeance of each of the separators used in these test cells. In FIG. 1, the horizontal axis indicates the separator air permeance and the vertical axis indicates the discharge and charge load characteristics. In the graph, the symbols “∘”, “”, “□” and “▪” indicate the discharge load characteristics of the test cells of Examples, the discharge load characteristics of the test cells of Comparative Examples, the charge load characteristics of the test cells of Examples, and the charge load characteristics of the test cells of Comparative Examples, respectively (the same goes for FIG. 2 or later). That is, the symbols “” and “▪” are used in the graph to indicate the data of the test cells of Comparative Examples. However, the use of the symbols “” and “▪” to indicate the test cells of Comparative Examples does not necessarily mean that these test cells had poor characteristics as some of them had, for example, favorable discharge characteristics in spite of having poor charge load characteristics.

The test cells of Examples 2, 8 and 9 and Comparative Examples 6 to 8 were examples of using the same positive electrodes and the same negative electrodes but different separators that varied from each other in air permeance (and in average pore size). It can be seen from the graph of FIG. 1 that the discharge load characteristics of the test cells improved while the charge load characteristics deteriorated as the separator air permeance became lower (an improvement in the separator permeability).

FIG. 2 shows a graph depicting the relationship between the obtained discharge and charge load characteristics of each of the test cells of Examples 2 and 5 to 7 and Comparative Examples 4 and 5 and “C²/Vc” expressing the reactivity of each of the positive electrodes used in these test cells. In FIG. 2, the horizontal axis indicates “C²/Vc” and the vertical axis indicates the discharge and charge load characteristics.

The test cells of Examples 2 and 5 to 7 and Comparative Examples 4 and 5 were examples of using the same negative electrodes and the same separators but different positive electrodes that varied from each other in the initial charge capacity C per 1 g of positive electrode active material, and the volume density and the capacity per unit area of their positive electrode material mixture layers. As for each of the negative electrodes used in these test cells, the capacity per unit area was 4.89 mAh/cm², the volume density Va of the negative electrode material mixture layer was 69.98 vol. %, and the capacity A was 370 mAh/g. Further, as for each of the separators used in these test cells, the air permeance was 90 sec./100 mL and the average pore size d was 72.8 nm.

It can be seen from the graph of FIG. 2 that with a gain in “C²/Vc” the discharge load characteristics of the test cells tended to improve somewhat and the charge load characteristics tended to remain invariant to some extent within the specific range. On the other hand, when “C²/Vc” fell below the specific value, the discharge and charge load characteristics of the test cells deteriorated significantly. The test cell with the largest value of “C²/Vc” showed deterioration of discharge and charge load characteristics but this test cell was an example in which the volume density Vc of the positive electrode was below the specific value (Comparative Example 4). Thus, it is clear from these results that the discharge and charge load characteristics of the lithium-ion secondary battery can be maintained at a high level by controlling the reactivity “C²/Vc” of the positive electrode and the volume density of the positive electrode material mixture layer.

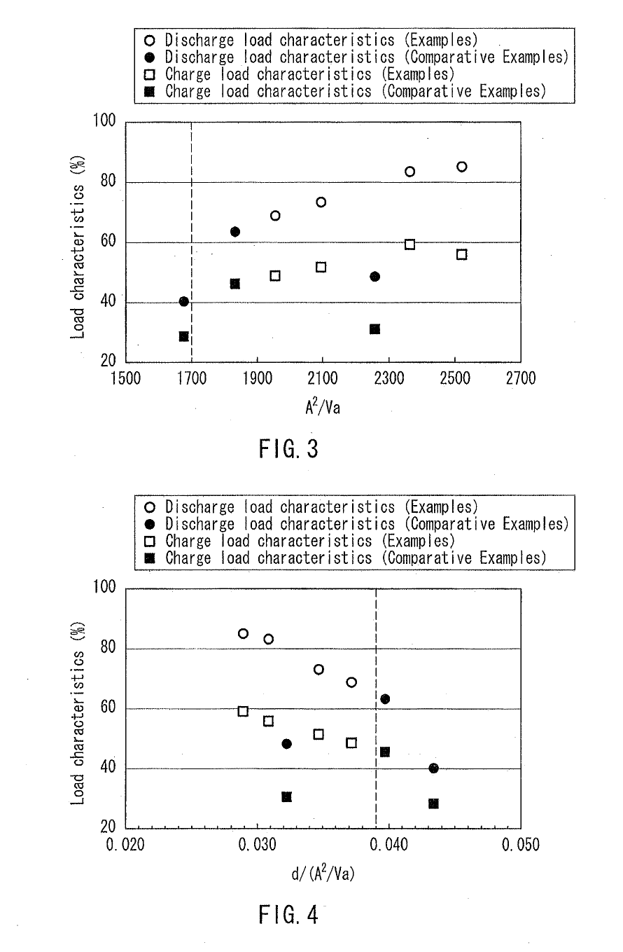

FIG. 3 shows a graph depicting the relationship between the obtained discharge and charge load characteristics of each of the test cells of Examples 1 to 4 and Comparative Examples 1 to 3 and “A²/Va” expressing the reactivity of each of the negative electrodes used in these test cells. In FIG. 3, the horizontal axis indicates “A²/Va” and the vertical axis indicates the discharge and charge load characteristics.

The test cells of Examples 1 to 4 and Comparative Examples 1 to 3 were examples of using the same positive electrodes and the same separators but different negative electrodes that varied from each other in the initial discharge capacity A per 1 g of negative electrode active material, and the volume density and the capacity per unit area of their negative electrode material mixture layers. As for each of the positive electrodes used in these test cells, the capacity per unit area was 3.7 mAh/cm², the volume density Vc of the positive electrode material mixture layer was 64.7 vol. %, and the capacity C was 185 mAh/g. Further, as for each of the separators used in these test cells, the air permeance was 90 sec./100 mL and the average pore size d was 72.8 nm.

It can be seen from the graph of FIG. 3 that with a gain in “A²/Va” the discharge and charge load characteristics of the test cells tended to improve. On the other hand, when “A²/Va” fell below the specific value, the discharge and charge load characteristics of the test cells deteriorated significantly. The test cell with the value of “A²/Va” being around 2250 showed deterioration of discharge and charge load characteristics but this test cell was an example in which the volume density Va of the negative electrode was below the specific value (Comparative Example 1).

Further, FIG. 4 shows a graph depicting the relationship between the obtained discharge and charge load characteristics of each of the test cells of Examples 1 to 4 and Comparative Examples 1 to 3 and “d/(A²/Va)” of these test cells. In FIG. 4, the horizontal axis indicates “d/(A²/Va)” and the vertical axis indicates the discharge and charge load characteristics.

It can be seen from the graph of FIG. 4 that as “d/A²/Va” became smaller the discharge and charge load characteristics of the test cells tended to improve. The test cell with the value of “d/(A²/Va)” being around 0.032 showed deterioration of discharge and charge load characteristics but this test cell was an example in which the volume density Va of the negative electrode was below the specific value (Comparative Example 1).

It is clear from the results shown in FIGS. 3 and 4 that the discharge load characteristics of the lithium-ion secondary battery can be improved while also improving the charge load characteristics by adjusting “d/(A²/Va)” as the relationship between the average pore size d of the separator and the reactivity “A²/Va” of the negative electrode, in addition to controlling the reactivity “A²/Va” of the negative electrode and the volume density Va of the negative electrode material mixture layer.

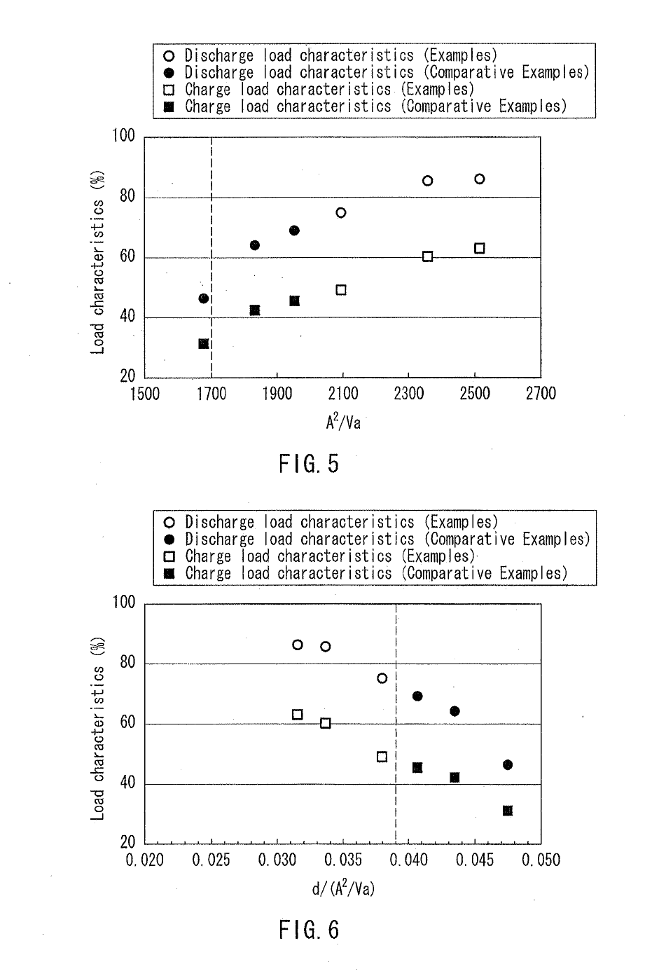

FIG. 5 shows a graph depicting the relationship between the obtained discharge and charge load characteristics of each of the test cells of Examples 10 to 12 and Comparative Examples 6, 9 and 10 and “A²/Va” expressing the reactivity of each of the negative electrodes used in these test cells. In FIG. 5, the horizontal axis indicates “A²/Va” and the vertical axis indicates the discharge and charge load characteristics.

The test cells of Examples 10 to 12 and Comparative Examples 6, 9 and 10 were examples of using the same positive electrodes and the same separators but different negative electrodes that varied from each other in the initial discharge capacity A per 1 g of negative electrode active material, and the volume density and the capacity per unit area of their negative electrode material mixture layers. As for each of the positive electrodes used in these test cells, the capacity per unit area was 3.7 mAh/cm², the volume density Vc of the positive electrode material mixture layer was 64.7 vol. %, and the capacity C was 185 mAh/g. Further, as for each of the separators used in these test cells, the air permeance was 45 sec./100 mL and the average pore size d was 79.7 nm.

As in the case of the graph of FIG. 3, it can be seen also from the graph of FIG. 5 that with a gain in “A²/Va” the discharge and charge load characteristics of the test cells tended to improve. On the other hand, when “A²/Va” fell below the specific value, the level of deterioration of the discharge and charge load characteristics of the test cells increased.

Further, FIG. 6 shows a graph depicting the relationship between the obtained discharge and charge load characteristics of each of the test cells of Examples 10 to 12 and Comparative Examples 6, 9 and 10 and “d/(A²/Va)” of these test cells. In FIG. 6, the horizontal axis indicates “d/(A²/Va)” and the vertical axis indicates the discharge and charge load characteristics.

As in the case of the graph of FIG. 4, it can be seen also from the graph of FIG. 6 that as “d/(A²/Va)” became smaller the discharge and charge load characteristics of the test cells tended to improve.

As is clear from the results shown in FIGS. 5 and 6 of the test cells of Examples 10 to 12 and Comparative Examples 6, 9 and 10 that used separators different in air permeance and average pore size from those used in the test cells of Examples 1 to 4 and Comparative Examples 1 to 3 whose evaluation results are shown in FIGS. 3 and 4, the discharge load characteristics of the lithium-ion secondary battery can be improved while also improving the charge load characteristics by adjusting “d/(A²/Va)” as the relationship between the average pore size d of the separator and the reactivity “A²/Va” of the negative electrode in addition to controlling the reactivity “A²/Va” of the negative electrode and the volume density Va of the negative electrode material mixture layer.

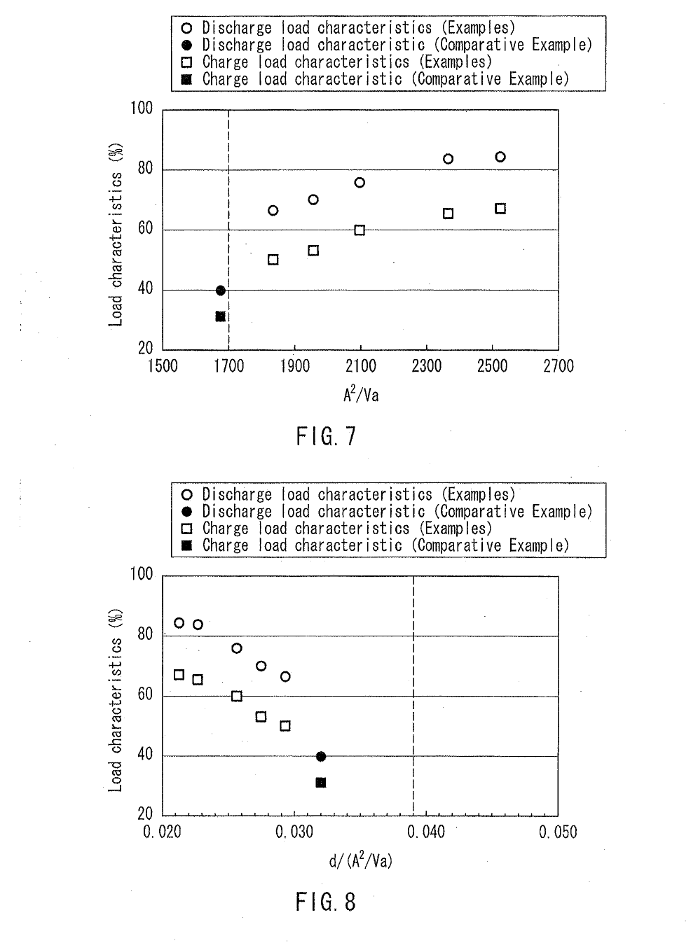

FIG. 7 shows a graph depicting the relationship between the obtained discharge and charge load characteristics of each of the test cells of Examples 9 and 13 to 16 and Comparative Example 11 and “A²/Va” expressing the reactivity of each of the negative electrodes used in these test cells. In FIG. 7, the horizontal axis indicates “A²/Va” and the vertical axis indicates the discharge and charge load characteristics.

The test cells of Examples 9 and 13 to 16 and Comparative Example 11 were examples of using the same positive electrodes and the same separators but different negative electrodes that varied from each other in the initial discharge capacity A per 1 g of negative electrode active material, and the volume density and the capacity per unit area of their negative electrode material mixture layers. As for each of the positive electrodes used in these test cells, the capacity per unit area was 3.7 mAh/cm², the volume density Vc of the positive electrode material mixture layer was 64.7 vol. %, and the capacity C was 185 mAh/g. Further, as for each of the separators used in these test cells, the air permeance was 60 sec./100 mL and the average pore size d was 53.6 nm.

As in the case of the graphs of FIGS. 3 and 5, it can be seen also from the graph of FIG. 7 that with a gain in “A²/Va” the discharge and charge load characteristics of the test cells tended to improve. On the other hand, when “A²/Va” fell below the specific value, the level of deterioration of the discharge and charge load characteristics of the test cells increased.

Further, FIG. 8 shows a graph depicting the relationship between the obtained discharge and charge load characteristics of each of the test cells of Examples 9 and 13 to 16 and Comparative Example 11 and “d/(A²/Va)” of these test cells. In FIG. 8, the horizontal axis indicates “d/(A²/Va)” and the vertical axis indicates the discharge and charge load characteristics.

As in the case of the graphs of FIGS. 4 and 6, it can be seen also from the graph of FIG. 8 that as “d/(A²/Va)” became smaller the discharge and charge load characteristics of the test cells tended to improve.

As is clear from the results shown in FIGS. 7 and 8 of the test cells of Examples 9 and 13 to 16 and Comparative Example 11 that used separators different in air permeance and average pore size from those used in the test cells of Examples 1 to 4 and Comparative Examples 1 to 3 whose evaluation results are shown in FIGS. 3 and 4 and from those used in the test cells of Examples 10 to 12 and Comparative Examples 6, 9 and 10 whose evaluation results are shown in FIGS. 5 and 6, the discharge load characteristics of the lithium-ion secondary battery can be improved while also improving the charge load characteristics by adjusting “d/(A²/Va)” as the relationship between the average pore size d of the separator and the reactivity “A²/Va” of the negative electrode, in addition to controlling the reactivity “A²/Va” of the negative electrode and the volume density Va of the negative electrode material mixture layer.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A lithium-ion secondary battery comprising a positive electrode, a negative electrode, a separator and a nonaqueous electrolyte,
wherein the positive electrode is provided with a positive electrode material mixture layer containing a positive electrode active material,
the positive electrode material mixture layer has a volume density Vc of 62 vol. % or more and a capacity per unit area of 2 mAh/cm² or more,
the positive electrode satisfies the following formula (1):
C²/Vc≧200 (1)
where C (mAh/g) is the initial charge capacity per 1 g of positive electrode active material, C being measured using Li as a counter electrode and at a charge voltage of 4.2 V,
the negative electrode is provided with a negative electrode material mixture layer containing a negative electrode active material,
the negative electrode material mixture layer has a volume density Va of 62 vol. % or more and a capacity per unit area of 2.5 mAh/cm² or more,
the negative electrode satisfies the following formula (2):
A²/Va≧1700 (2)
where A (mAh/g) is the initial discharge capacity per 1 g of negative electrode active material, A being measured using Li as a counter electrode and at a discharge voltage of 0.01 V,
the separator has an air permeance of 200 sec./100 mL or less, the air permeance being determined by the Gurley method,
the separator satisfies the following formula (3):
d/(A²/Va)≦0.039 (3)
where d (nm) is an average pore size of the separator, and
the positive electrode and the negative electrode satisfy the following formula (4):
(A²/Va)/(C²/Vc)≦30 (4).

2. The lithium-ion secondary battery according to claim 1, wherein the value of C²/Vc is 450 or more.

3. The lithium-ion secondary battery according to claim 1, wherein the air permeance of the separator determined by the Gurley method is 100 sec./100 mL or less.

4. The lithium-ion secondary battery according to claim 1, wherein the value of d/(A²/Va) is 0.033 or less.

5. The lithium-ion secondary battery according to claim 1, wherein the negative electrode active material includes a material containing silicon and oxygen as constituent elements.
